(19) United States
(12) Patent Application Publication
(10) Pub. No.: US 2020/0300197 A1
(43) Pub. Date: Sep. 24, 2020

(54) CASING FOR A PROPELLANT FEED TURBOPUMP FOR A ROCKET ENGINE

(71) Applicant: ARIANEGROUP SAS, Paris (FR)

(72) Inventor: Davide Duri, Pressagny L'Ougueilleux (FR)

(73) Assignee: ARIANEGROUP SAS, Paris (FR)

(21) Appl. No.: 16/088,563

(22) PCT Filed: Mar. 27, 2017
(86) PCT No.: PCT/FR2017/050697

§ 371 Date: Sep. 26, 2018

(30) Foreign Application Priority Data
Apr. 1, 2016 (FR) 1652879

(51) Int. Cl. F02K 9/48; F02K 9/60

(52) U.S. Cl. CPC F02K 9/48; B64G 1/402; F02K 9/60

(57) ABSTRACT

A casing (20) of a propellant feed turbopump (10) for a rocket engine (50), the casing including a cooling circuit (30), wherein the cooling circuit is formed at least in part in a wall of said casing (20).

### FIELD OF THE INVENTION

The invention relates to a casing of a propellant feed turbopump for a rocket engine, to a rocket engine propellant feed turbopump including such a casing, and to a rocket engine fitted with such a turbopump.

### BACKGROUND

In general, prior to starting a rocket engine propellant feed turbopump, it needs to be cooled down. Cooling down is in operation during which all or part of the turbopump casing is taken to a predetermined temperature, generally by cooling it, so that the turbopump is in its required operating conditions.

Known circuits for cooling rocket engine propellant feed turbopumps are generally complex and present fluid flow connections with the pumping circuit of the turbopump for feeding propulsion propellant to the rocket engine combustion chamber, such that using such circuits for cooling purposes is often difficult. Furthermore, for manifest safety reasons, the cooling fluid used for cooling down is always identical to the propulsion propellant in order to avoid any risk of explosion. This imposes several constraints that it would be desirable to avoid. There therefore exists a need in this sense.

### SUMMARY OF THE INVENTION

The present disclosure relates to a casing of a propellant feed turbopump for a rocket engine.

An embodiment provides a casing of a propellant feed turbopump for a rocket engine, the casing including a cooling circuit, wherein the cooling circuit is formed at least in part in a wall of said casing.

It can be understood that the casing of the turbopump may be formed as a single-piece part, or else as a plurality of distinct pieces that once assembled together form the complete casing of the turbopump.

It can also be understood that the turbopump presents a pumping circuit for pumping propellant to the combustion chamber of the rocket engine for propulsion purposes (i.e. the propulsion propellant), a drive circuit in which there flows a propellant for driving the turbine of the turbopump in rotation (i.e. a drive propellant), and a cooling circuit. It can also be understood that the pumping circuit, the drive circuit, and the cooling circuit do not present any fluid duct in common, and are therefore mutually independent. The pumping circuit, the drive circuit, and the cooling circuit are thus in fluid flow isolation from one another. In other words, the cooling circuit is a circuit dedicated solely to cooling and that is used only for cooling.

It can also be understood that the cooling circuit for cooling the turbopump presents ducts that are integrated in at least one wall of the casing of the turbopump. In other words, the cooling circuit includes at least one duct extending in the thickness of a wall of the casing. This makes it possible to improve the cooling of the casing, while also providing complete separation between the cooling circuit and both the pumping circuit and also the turbopump drive circuit.

Having a cooling circuit that is distinct from the pumping circuit makes it possible to be unaffected by the constraints associated with having a fluid for cooling purposes (i.e. the cooling fluid) and then a propulsion propellant (i.e. a propellant that is to be injected into the combustion chamber for propulsion purposes) both flowing in succession in ducts that are common.

Finally, the independence between the pumping circuit, the drive circuit, and the cooling circuit makes it possible to cool the turbopump with a propellant that is different from the propellant that is to flow in the pumping circuit and the propellant that is to flow in the drive circuit. This is made possible only because the cooling circuit is distinct, and thus presents no fluid duct in common with the pumping circuit or with the drive circuit. Specifically, if the circuits were not distinct, it would be particularly dangerous to cause two different propellants to flow in succession one after the other in a common duct since that would present a risk of explosion by reaction between the two propellants. It is thus possible to select a cooling fluid, e.g. a propellant, for cooling the turbopump independently of the natures of the propellant(s) flowing in the pumping circuit and in the drive circuit of the turbopump. It should be observed that the propulsion propellant is not necessarily identical to the drive propellant.

In some embodiments, the cooling circuit extends at least in part in a wall of a pump inlet portion of the turbopump.

It can thus be understood that the casing includes a portion that forms an inlet for the pumping circuit. Since the cooling circuit presents a duct in a wall of this inlet portion, it is possible to cool this portion in very effective manner, which portion is the first to come into contact with the propulsion propellant. This serves to avoid this inlet portion suffering from thermal shocks when starting the turbopump, and also to avoid unwanted heating of the propulsion propellant that could lead to said propellant vaporizing in part, which would run the risk of cavitation within the turbopump.

In some embodiments, the cooling circuit extends at least in part in a wall of a volute portion of the turbopump.

It can be understood that the casing comprises a portion that forms a volute, with the pumping circuit passing through the volute. Since the cooling circuit presents a duct in a wall of this volute portion, it is possible to cool this portion in a very effective manner, which portion comes into contact with a large volume of propulsion propellant. This serves to avoid the volute portion being subjected to thermal shocks when starting the turbopump, and also to avoid unwanted heating of the propulsion propellant that could lead to said propellant vaporizing in part, which would run the risk of cavitation within the turbopump.

In some embodiments, the cooling circuit extends at least in part in a wall of a portion configured to receive a bearing.

It can be understood that the casing includes a portion in which a bearing is located, e.g. a bearing supporting the rotor of the turbopump. Since the cooling circuit presents a duct in a wall of this portion, it is possible to cool this portion in very effective manner, which portion needs to have its temperature controlled very accurately in order to ensure good operating conditions for the bearing.

In some embodiments, the cooling circuit includes a duct outside the walls of said casing.

It can be understood that such ducts are not provided in the thickness of a wall of the casing. By way of example, such a duct makes it possible to connect together the ducts formed in the walls of different portions of the casing. This makes it possible to avoid mechanically weakening the casing by generating too many zones having ducts formed in a wall of the casing, and to avoid cooling portions of the casing of the turbopump that do not need to be cooled.

The present disclosure also provides a propellant feed turbopump for a rocket engine, the turbopump including a casing according to any of the embodiments described in the present disclosure.

The present disclosure also provides a rocket engine including a rocket engine propellant feed turbopump according to any of the embodiments described in the present disclosure.

The present disclosure also provides a method of fabricating a casing of a propellant feed turbopump for a rocket engine according to any of the embodiments described in the present disclosure and comprising at least one step of additive manufacturing.

It should be recalled that additive manufacturing is a method of manufacturing by adding material, by stacking successive layers.

Such a method of manufacture is particularly well adapted to manufacturing complex parts, such as the turbopump casing of the present disclosure.

### BRIEF DESCRIPTION OF THE DRAWINGS

The invention and its advantages can be better understood on reading the following detailed description of various embodiments of the invention given as nonlimiting examples. The description makes reference to the accompanying sheets of figures, in which:

FIG. 1 shows a space vehicle fitted with a rocket engine;

FIG. 2A is a half-view in section of the turbopump of the FIG. 1 space vehicle rocket engine;

FIG. 2B is a diagram showing the layout of the turbopump cooling circuit; and

FIG. 3 is a diagram showing an example of a complete circuit for cooling the FIG. 2A turbopump within the space vehicle.

### DETAILED DESCRIPTION OF EMBODIMENTS

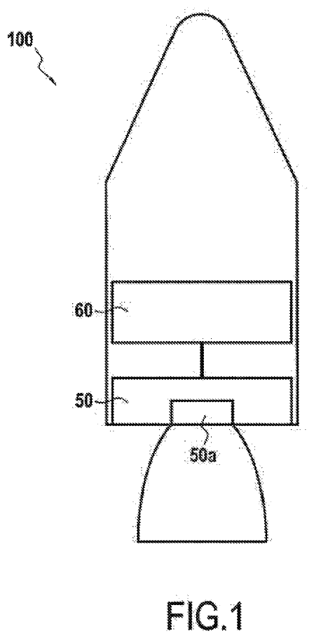

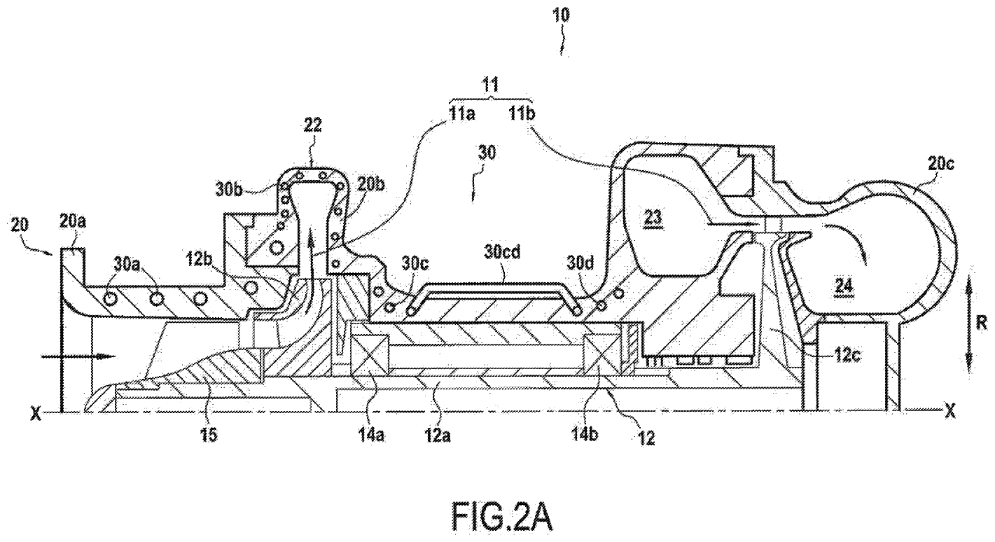

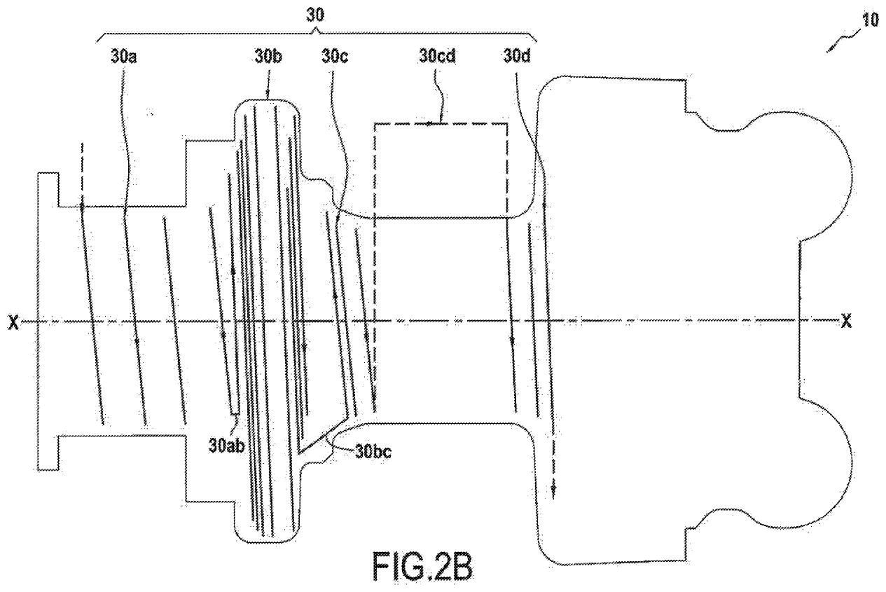

FIG. 1 shows a space vehicle 100 having a rocket engine 50 fed from a propellant tank 60. FIG. 2A is a half-view in section parallel to the axial direction X of a turbopump 10 for feeding propellant to the rocket engine 50.

The propellant feed turbopump 10 comprises various internal elements drawn in fine lines, and in particular a rotor 12 having a shaft 12a, an inducer 15, an impeller 12b, and a turbine wheel 12c. The rotor 12 is supported to rotate within the turbopump 10 by bearings 14a and 14b. The axis of rotation of the rotor 12 defines the axial direction X of the turbopump 10. Below, and unless mentioned to the contrary, the radial direction R is a direction perpendicular to the axis X. The azimuth direction corresponds to the direction describing a ring around the axial direction. The axial, radial, and azimuth directions correspond respectively to the directions defined by the height, the radius, and the angle in a cylindrical coordinate system.

The enclosure of the turbopump 10 is defined by the casing 20, drawn in bold lines. In this example, the casing 20 comprises three distinct elements, namely a pump inlet casing 20a, an intermediate casing 20b, and a turbine outlet casing 20c. Together, these inlet, intermediate, and outlet casings form the casing 20.

Bold arrows represent the flow of propulsion propellant, i.e. the propellant that is pumped by the turbopump 10 in order to be sent to the combustion chamber 50a of the rocket engine 50.

The propulsion propellant enters into the turbopump 10 via the pump inlet casing 20a, passes via the inducer 15, and then via the impeller 12b, which sucks in the propellant and discharges it into the volute 22 formed by a portion of the intermediate casing 20b. The propellant pressurized in this way flows from the volute 22 via a tangential outlet, not shown. These passages form the pumping circuit 11a.

The pressurized propellant is then taken to the combustion chamber 50a (see FIG. 1).

The flow of propellant for driving the turbine 12c is also represented by bold arrows. The drive propellant which may be in various forms, themselves known to the person skilled in the art (e.g. after being heated or after being burnt in full or in part), is introduced via an inlet (not shown) into the “turbine upstream cavity” 23 formed by a portion of the intermediate casing 20b, then flows through the turbine 12c, thereby driving the rotor 12 in rotation, and subsequently reaches the exhaust cavity 24 as defined by the turbine outlet casing 20c so as to be discharged from the pump 10 via an outlet (not shown). These passages form of the drive circuit 11b for driving the turbine 12c.

It can be considered that the pumping circuit 11a and the drive circuit 11b of the turbine 12c form a main circuit 11 in which the “main” propellants of the turbopump flow. The pumping circuit 11a forms part of the feed circuit for feeding the combustion chamber 50a. The drive circuit 11b does not form part of the feed circuit (i.e. the circuit for feeding propellant to the combustion chamber). It should be observed that the propulsion propellant and the drive propellant are generally, but not necessarily, different. The turbopump presents means (not shown) that are themselves known for providing isolation between the pumping circuit and the drive circuit.

With reference to FIGS. 2A and 2B, there follows a description of the cooling circuit 30 for cooling the casing 20 of the turbopump 10. The casing 20 presents a plurality of walls having ducts formed therein. In this example, each of these ducts forms a portion of the cooling circuit 30.

The pump inlet casing 20a, which forms a pump inlet portion of the turbopump 10, presents an annular duct 30a formed in its wall and extending in the axial direction X. Thus, the duct 30a presents a shape that is generally helical about the axis X.

The intermediate casing 20b, which forms in particular a volute 22 or a volute portion of the turbopump 10, presents an annular duct 30b formed in its wall and extending both in the axial direction X and in the radial direction R. Thus, the duct 30b presents a shape that is generally helical and of varying radius about the axis X.

The intermediate casing 20b likewise presents two portions 20ba and 20bb respectively configured to receive the bearings 14a and 14b. These portions present respective annular ducts 30c and 30d formed in their walls, which ducts extend both in the axial direction X and also in the radial direction R. Thus, each of the ducts 30c and 30d presents a shape that is generally helical and of varying radius about the axis X.

The ducts 30a and 30b are connected together by an intermediate duct 30ab formed in the walls of the pump inlet casing 20a and of the intermediate casing 20b. The ducts 30b and 30c are also connected together by an intermediate duct 30bc formed in the wall of the intermediate casing 20b. Finally, the ducts 30c and 30d are connected together by a duct 30cd that is outside the wall of the intermediate casing 20b. The ducts 30a, 30ab, 30b, 30bc, 30c, 30cd, and 30d form of the cooling circuit 30 for cooling the turbopump 10, and more particularly for cooling the casing 20 of the turbopump 10.

FIG. 2B shows a diagrammatic view of the cooling circuit 30 within the casing 20 of the turbopump 10. The flow direction of the cooling fluid within the circuit 30 is indicated by arrows. It should be observed that the inlet and the outlet of the circuit 30 are represented in symbolic manner by discontinuous lines for illustrative and instructional purposes. In like manner, it is possible to envisage any other shape for the ducts of the cooling circuit 30, and the example shown in FIGS. 2A and 2B is illustrative rather than limiting. Naturally, it is also possible to envisage providing ducts of the cooling circuit 30 in any other portions of the casing 20 of the turbopump 10.

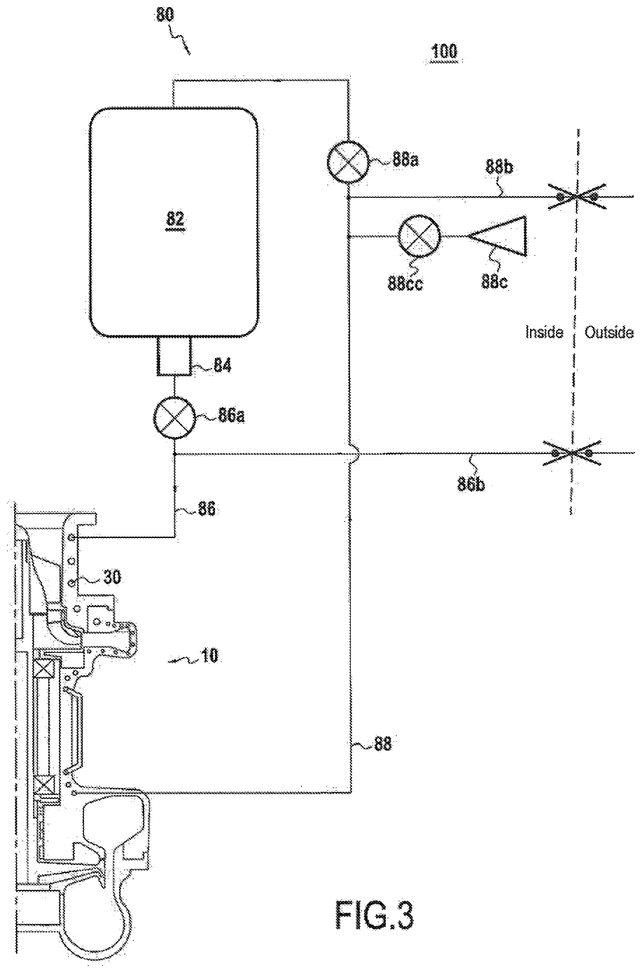

With reference to FIG. 3, there follows a description of an example of a complete cooling circuit 80 for the turbopump 10 within the space vehicle 100. Naturally, the complete cooling circuit 80 includes the cooling circuit 30 that forms part of the turbopump 10.

The complete cooling circuit 80 comprises a propellant tank 82 containing a propellant that is used as a cooling fluid for cooling the turbopump 10. It should be observed that the propellant tank 82 could be a tank that is configured to receive only a propellant for use in cooling the turbopump 10 (as shown in FIG. 3—the tank 60 and the tank 82 then being tanks that are distinct), or else a tank that also serves for feeding the pumping circuit of the turbopump with propulsion propellant (variant not shown). Under such circumstances, the tank 82 and the tank 60 coincide and form a single tank 82, this tank 82 then being the only element that is common to the feed circuit (i.e. the circuit dedicated to feeding the propulsion propellant) and to the complete cooling circuit 80, which nevertheless remain distinct and independent of each other. For example, the two circuits are kept independent by on/off valves, check valves, or any other device known to the person skilled in the art.

A motor-driven pump 84 sends the propellant from the tank 82 to a propellant feed pipe 86 taking the propellant to the circuit 30 of the turbopump 10. This pipe 86 has a valve 86a for isolating the circuit 30 from the tank 82.

A return pipe 88 serves to take the propellant that has flowed through the circuit 30 and return it back to the tank 82. The pipe 88 is fitted with a valve 88a so as to enable the tank 82 to be isolated from the circuit 30.

The propellant feed pipe 86 and the return pipe 88 have respective branch circuits 86b and 88b, respectively forming an inlet branch circuit and an outlet branch circuit, so as to enable the circuit 80 to communicate with the outside of the space vehicle 100. By means of these branch circuits, it is possible for example to cause a cooling fluid to flow in the circuit 80 while the space vehicle is on the ground, so as to conserve the propellant contained in the tank 82 for additional cooling performed in flight.

Furthermore, the return pipe 88 has a discharge nozzle 88c that is isolated from the pipe 88 by a valve 88cc. Thus, it is possible to purge the circuit 80 by opening the valve 88cc in order to discharge all of the fluid contained in the circuit 80 to outside the space vehicle 100.

By means of the complete cooling circuit 80, it is thus possible to cool the turbopump 10 while the space vehicle 100 is on the ground via the branch circuits 86b and 88b, with the valves 86a and 88a being closed, or else in independent manner, whether in flight or on the ground, by using the propellant contained in the tank 82 (the branch circuits 86b and 88b naturally then being shut off). In order to purge the circuit 80, the valves 86a and 88a are closed (unless it is desired also to purge the tank 82), and the valve 88cc of the discharge nozzle 88c is opened. While it is being used, it is also possible to discharge the cooling propellant progressively via the nozzle 88c, in which case the valves 86a and 88cc are opened, while the valve 88a is closed.

Naturally, in a variant, the complete cooling circuit 80 does not have a branch circuit to the outside. In another variant, the complete cooling circuit 80 does not have a tank 82, but only has branch circuits to the outside. In yet another variant, the return pipe 88 leads directly into the discharge nozzle 88c and is not connected to the tank 82 (the propellant feed pipe 86 being connected to the tank 82 and/or to the branch circuit 86b). Furthermore, the discharge nozzle is optional.

Although the present invention is described with reference to specific embodiments, it is clear that modifications and changes may be made to those embodiments without going beyond the general ambit of the invention as defined by the claims. In particular, individual characteristics of the various embodiments that are illustrated and/or mentioned may be combined in additional embodiments. Consequently, the description and the drawings should be considered in a sense that is illustrative rather than restrictive.

1. A casing of a propellant feed turbopump for a rocket engine, the casing including a cooling circuit, wherein the cooling circuit is formed at least in part in a wall of said casing.

2. The casing according to claim 1, wherein the cooling circuit extends at least in part in a wall of a pump inlet portion of the turbopump.

3. The casing according to claim 1, wherein the cooling circuit extends at least in part in a wall of a volute portion of the turbopump.

4. The casing according to claim 1, wherein the cooling circuit extends at least in part in a wall of a portion configured to receive a bearing.

5. The casing according to claim 1, wherein the cooling circuit includes a duct outside the walls of said casing.

6. A propellant feed turbopump for a rocket engine, the turbopump including a casing according to claim 1.

7. A rocket engine including a propellant feed turbopump for a rocket engine according to claim 6.

8. A method of fabricating a casing of a propellant feed turbopump for a rocket engine according to claim 1, comprising at least one step of additive manufacturing.
